(19) United States
(12) Patent Application Publication
(10) Pub. No.: US 2025/0367884 A1
(43) Pub. Date: Dec. 4, 2025

(54) MATERIAL SUPPLYING DEVICE, THREE DIMENSIONAL MOLDING DEVICE, AND INJECTION MOLDING DEVICE

(71) Applicant: SEIKO EPSON CORPORATION, Tokyo (JP)

(72) Inventor: Masaaki OGIHARA, MATSUMOTO-SHI (JP)

(21) Appl. No.: 19/219,662

(22) Filed: May 27, 2025

(30) Foreign Application Priority Data
May 28, 2024 (JP) 2024-085937

(51) Int. Cl. B29C 64/393; B29C 45/77; B29C 64/321; B33Y 30/00; B33Y 40/00; B33Y 50/02

(52) U.S. Cl. CPC B29C 64/393; B29C 45/77; B29C 64/321; B33Y 30/00; B33Y 40/00; B33Y 50/02; B29C 2945/76006; B29C 2945/76287; B29C 2945/76351; B29C 2945/76498; B29C 2945/76658; B29C 2945/76859

(57) ABSTRACT

A material supplying device includes a plasticizing section configured to plasticize a material to generate a plasticization material; a nozzle configured to supply the plasticization material to the outside; a supply control mechanism that is provided in a flow path communicating with the plasticizing section and the nozzle, and that is configured to adjust a supply amount of the plasticization material from the nozzle to the outside; a pressure sensor configured to measure the pressure of the plasticization material in the flow path; and a control section configured to control an operation of the supply control mechanism, wherein the control section is configured to calculate a backlash value indicating backlash of the supply control mechanism based on detection data including a detection value output from the pressure sensor, and the detection data is data including in time series the detection values output from the pressure sensor.

The present application is based on, and claims priority from JP Application Serial Number 2024-085937, filed May 28, 2024, the disclosure of which is hereby incorporated by reference herein in its entirety.

### BACKGROUND

### 1. Technical Field

The present disclosure relates to a material supplying device, a three dimensional molding device, and an injection molding device.

### 2. Related Art

The three dimensional molding device disclosed in JP-A-2021-62566 is provided with a flow rate adjusting mechanism for adjusting the ejection amount of plasticization material from an ejection section.

Backlash exists in the mechanical parts constituting the flow rate adjusting mechanism. In the related art, it has been difficult to measure the backlash without disassembling the device.

### SUMMARY

According to a first aspect of the present disclosure, a material supplying device is provided.

This material supplying device includes a plasticizing section configured to plasticize a material to generate a plasticization material; a nozzle configured to supply the plasticization material to outside; a supply control mechanism that is provided in a flow path communicating with the plasticizing section and the nozzle and that is configured to adjust supply amount of the plasticization material from the nozzle to outside; a pressure sensor configured to measure the pressure of the plasticization material in the flow path; and a control section configured to control operation of the supply control mechanism, wherein the control section is configured to calculate a backlash value indicating backlash of the supply control mechanism based on detection data including a detection value output from the pressure sensor and the detection data is data including, in time series, the detection values output from the pressure sensor in at least a part of a period during a first operation of using the supply control mechanism to reduce the supply amount of the plasticization material from the nozzle and a period during a second operation of using the supply control mechanism to increase the supply amount of the plasticization material from the nozzle.

According to a second aspect of the present disclosure, there is provided a three dimensional molding device including the above described material supplying device and a stage on which the plasticization material is supplied from the material supplying device and deposited.

According to a third aspect of the present disclosure, there is provided an injection molding device including the material supplying device and a molding die clamping device configured to cause the molding die, which has a cavity into which the plasticization material is supplied from the material supplying device, to open and close.

### BRIEF DESCRIPTION OF THE DRAWINGS

FIG. 1 is an explanatory view showing a schematic configuration of a three dimensional molding device.

FIG. 2 is an explanatory view showing a schematic configuration of the three dimensional molding device.

FIG. 3 is a perspective view showing a schematic configuration of a screw.

FIG. 4 is a schematic plan view of a barrel.

FIG. 5 is a perspective view of a movable section and a material supplying device.

FIG. 6 is a side view of the material supplying device.

FIG. 7 is a cross-sectional view showing a configuration of a suction feeding section and a pressure sensor.

FIG. 8 is an explanatory view of the operation of a plunger.

FIG. 9 is a view showing an enlarged cross-section of a portion of the plunger.

FIG. 10 is a flowchart of a three dimensional molding process.

FIG. 11 is an explanatory view showing a method of calculating the backlash.

FIG. 12 is an explanatory view showing the method of calculating the backlash.

FIG. 13 is an explanatory view showing a method of calculating the backlash according to a second embodiment.

FIG. 14 is an explanatory view showing the method of calculating the backlash according to the second embodiment.

FIG. 15 is an explanatory view showing a method of calculating the backlash according to a third embodiment.

FIG. 16 is an explanatory view showing a method of calculating the backlash according to a fourth embodiment.

FIG. 17 is an explanatory view showing a schematic configuration of an injection molding device according to a fifth embodiment.

### DESCRIPTION OF EMBODIMENTS

### A. First Embodiment

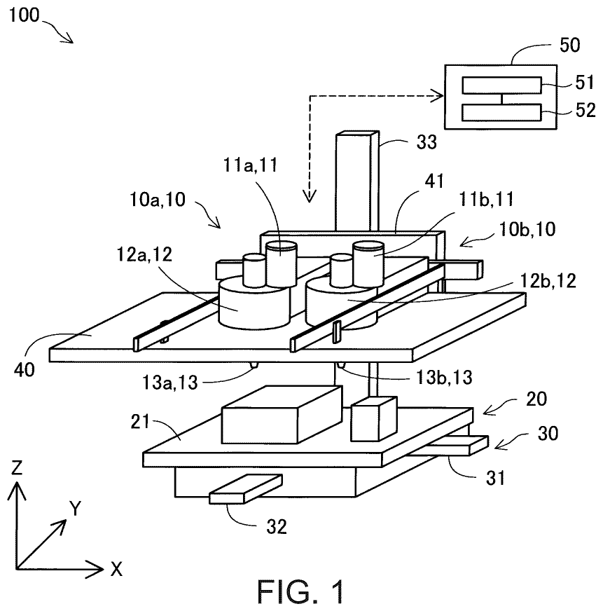

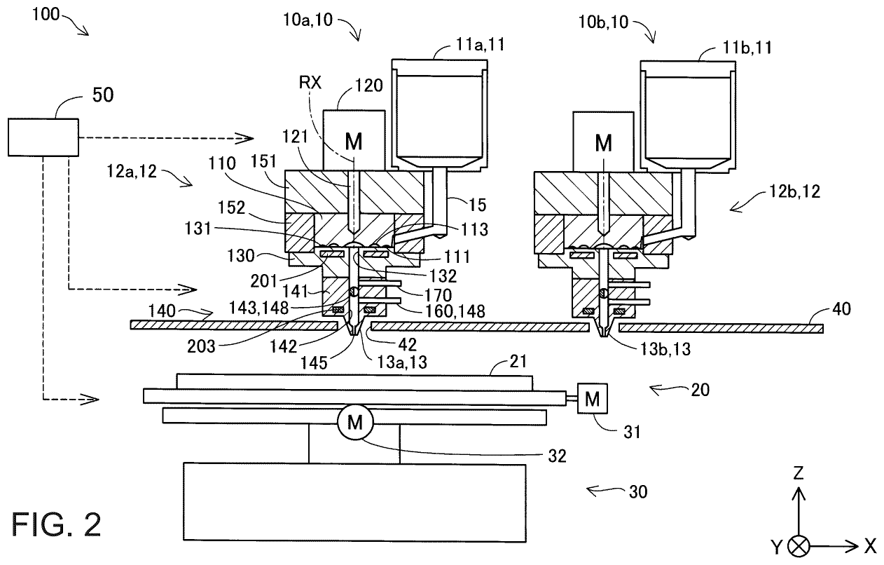

FIG. 1 and FIG. 2 explanatory view showing a schematic configuration of a three dimensional molding device 100 in a first embodiment. FIG. 1 and FIG. 2 show arrows indicating X, Y, and Z directions, which are orthogonal to each other. The X direction and the Y direction are directions parallel to a horizontal plane. The Z direction is a direction parallel to the vertical direction. The X, Y, and Z directions in FIG. 1 and FIG. 2 and the X, Y, and Z directions in other drawings indicate the same directions. When a direction is specified, positive and negative signs are used together with the direction notation, wherein the positive direction, which is the direction indicated by the arrow, is “+” and the negative direction, which is the direction opposite to the direction indicated by the arrow, is “−”. The Z direction corresponds to a “first direction”.

Three dimensional molding device 100 includes a material supplying device 10, a stage 20, a position changing section 30, a first heating section 40, and a control section 50.

The control section 50 controls each section of the three dimensional molding device 100. The control section 50 is configured by a computer including one or a plurality of processor 51, a storage section 52 including a main storage device and an auxiliary storage device, and an input/output interface that inputs and outputs signals to and from the outside. The processor 51 executes a three dimensional molding process (to be described later) in accordance with a program stored in the storage section 52. Note that the control section 50 may be realized by a configuration in which a plurality of circuits for realizing at least a part of each function are combined instead of being configured by the computer.

Under the control of the control section 50, the material supplying device 10 supplies and deposits a plasticization material, which is obtained by plasticizing a material in a solid state into a paste, to the stage 20 that serves as a base of a three dimensional molded object. The material supplying device 10 includes a material supplying section 11, a plasticizing section 12, and a nozzle 13. The material supplying device 10 is also referred to as a head.

The three dimensional molding device 100 includes, as the material supplying device 10, a first material supplying device 10a and a second material supplying device 10b. The first material supplying device 10a includes a first material supplying section 11a as the material supplying section 11, includes a first plasticizing section 12a as the plasticizing section 12, and a first nozzle 13a as the nozzle 13. The second material supplying device 10b includes a second material supplying section 11b as the material supplying section 11, a second plasticizing section 12b as the plasticizing section 12, and a second nozzle 13b as the nozzle 13. The first material supplying device 10a and the second material supplying device 10b are disposed side by side in the X direction so that their positions in the Y direction coincide with each other. The second material supplying device 10b is disposed at a position in the +X direction of the first material supplying device 10a. Since the configuration of the first material supplying device 10a and the configuration of the second material supplying device 10b are the same, hereinafter, when they are not particularly distinguished from each other, they may be simply referred to as material supplying device 10. When distinguishing the constituent members of each, the constituent members of the first material supplying device 10a are indicated by the symbol “a”, and the constituent members of the second material supplying device 10b are indicated by the symbol “b”.

The material supplying section 11 supplies a raw material for generating the plasticization material to the plasticizing section 12. The material supplying section 11 is constituted by, for example, a hopper. The pellet-like or powder-like raw material is accommodated in the material supplying section 11. As the raw material, for example, a thermoplastic resin such as polypropylene resin (PP), polyethylene resin (PE), or polyacetal resin (POM) is used. Below the material supplying section 11, a communication path 15 connecting the material supplying section 11 and the plasticizing section 12 is provided. The material supplying section 11 supplies the raw material to the plasticizing section 12 through the communication path 15.

The plasticizing section 12 plasticizes at least a part of the raw material supplied from the material supplying section 11, generates the plasticization material in the form of a paste having fluidity, and guides the plasticization material to the nozzle 13. Here, “plasticization” is a concept including melting, and is a change from a solid state to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point.

The plasticizing section 12 includes a screw 110, a screw drive motor 120, a barrel 130, and an ejection section 140.

As shown in FIG. 2, the screw 110 is housed in lower case 152. The upper surface side of the screw 110 is connected to the screw drive motor 120 via a drive shaft 121. By applying the driving force of the screw drive motor 120 to the drive shaft 121, the screw 110 rotates integrally with the drive shaft 121. A rotational axis RX of the screw 110 coincides with an axis of the drive shaft 121. An axial direction of the rotational axis RX of the screw 110 is a direction along the Z direction. The rotation speed of the screw 110 is controlled by the control section 50 controlling the rotation speed of the screw drive motor 120. The screw 110 may be driven by the screw drive motor 120 via a decelerator. The screw 110 is also referred to as a rotor or a flat screw. The drive shaft 121 is provided in the upper case 151, which is positioned above the lower case 152.

The barrel 130 is disposed on the −Z direction side of the screw 110. A facing surface 131, which is the upper surface of the barrel 130, faces a groove forming surface 111, which is the lower surface of the screw 110. A communication hole 132 communicating with a flow path 142 of the ejection section 140 is formed in the center of the barrel 130. Inside the barrel 130, a second heating section 201 for heating the material supplied to grooves 113 of the screw 110 (to be described later) is accommodated. Details of the barrel 130 will be described later.

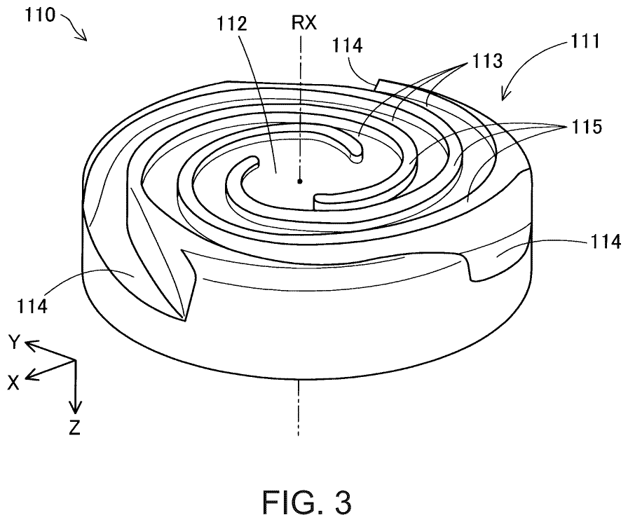

FIG. 3 is a perspective view showing a schematic configuration of the screw 110. The screw 110 has a substantially cylindrical shape whose length in a direction along the rotational axis RX is smaller than a length in a direction perpendicular to the rotational axis RX. On the groove forming surface 111, the vortex shape grooves 113 are formed around a central section 112. The grooves 113 communicate with introduction ports 114 formed in a side surface of the screw 110. The raw material supplied from the material supplying section 11 is supplied to the grooves 113 through the introduction ports 114. The grooves 113 are formed by being separated from each other by ridge sections 115. FIG. 3 shows an example in which three grooves 113 are formed, but the number of grooves 113 may be one, two, or more. The grooves 113 are not limited to a vortex shape, may be helical or involute curvilinear, and may extend so as to draw an arc from the central section 112 to the outer periphery.

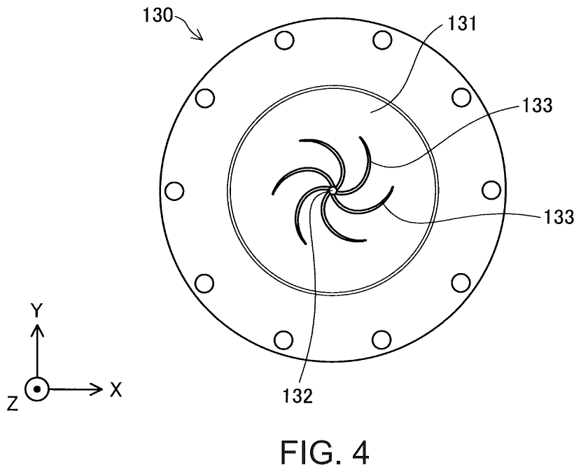

FIG. 4 is a schematic plan view of the barrel 130. The plurality of guide grooves 133 is formed around the communication hole 132 in the facing surface 131. Each guide groove 133 has one end connected to the communication hole 132 and extends in a vortex shape from the communication hole 132 toward the outer periphery of the facing surface 131. One end of the guide grooves 133 may not be connected to the communication hole 132. The guide grooves 133 may not be formed in the barrel 130.

The raw material supplied to the grooves 113 of the screw 110 flows along the grooves 113 while being plasticized in the grooves 113 by the rotation of the screw 110 and heating by the second heating section 201, and is guided to the central section 112 of the screw 110 as the plasticization material. The plasticization material in a state of paste that has exhibited fluidity and flowed into the central section 112 is supplied to the ejection section 140 via the communication hole 132. In the plasticizing section, not all types of substances constituting the plasticization material need to be plasticized. It is sufficient that the plasticization material is converted into a state having fluidity as a whole by plasticizing at least some kinds of substances among substances constituting the plasticization material.

The ejection section 140 shown in FIG. 2 includes a flow path block 141, a supply control mechanism 148, and a pressure sensor 170. The supply control mechanism 148 is provided in the flow path 142 communicating with the plasticizing section 12 and the nozzle 13 and adjusts a supply amount of the plasticization material from the nozzle 13 to the outside the nozzle 13. The supply control mechanism 148 includes a flow rate adjustment section 143 and a suction feeding section 160.

The flow path block 141 is disposed on the −Z direction side of the barrel 130. The flow path 142 is formed in the flow path block 141. A third heating section 203 for heating the flow path block 141 is accommodated inside the flow path block 141.

The nozzle 13 is provided at the lower end of the flow path block 141. The nozzle 13 is connected to the communication hole 132 of the barrel 130 through the flow path 142. The nozzle 13 ejects the plasticization material generated in the plasticizing section 12 from an ejection port 145 at the tip end of the nozzle 13 toward the stage 20.

The flow rate adjustment section 143 includes a valve disposed in the flow path 142. The flow rate adjustment section 143 is controlled by the control section 50. The control section 50 controls a rotational angle of the valve to change the opening degree of the flow path 142, thereby adjusting the flow rate of the plasticization material flowing from the plasticizing section 12 to the nozzle 13, that is, the flow rate of the plasticization material supplied from the nozzle 13 to the outside. The flow rate adjustment section 143 adjusts the flow rate of the plasticization material and controls the on/off of the outflow of the plasticization material. Note that the flow rate adjustment section 143 may have a shutter mechanism and adjust the flow rate of the plasticization material by changing the opening degree of the flow path 142 using the shutter mechanism.

The suction feeding section 160 is a mechanism for executing a first operation of reducing the supply amount of the plasticization material from nozzle 13 by sucking the plasticization material from flow path 142 and a second operation of increasing the supply amount of the plasticization material from nozzle 13 by sending out the sucked plasticization material to flow path 142. By executing the first operation, it is possible to suppress a tail-dragging phenomenon in which the plasticization material drips from nozzle 13 so as to pull a thread. By executing the second operation, it is possible to increase the responsiveness of the send out of the plasticization material from nozzle 13. The suction feeding section 160 is controlled by the control section 50. A specific configuration of the suction feeding section 160 will be described later.

When stopping ejection of the plasticization material from nozzle 13, the control section 50 first controls the flow rate adjustment section 143 to turn off the outflow of the plasticization material, and then controls the suction feeding section 160 to execute the first operation, thereby sucking the plasticization material from flow path 142. When resuming the ejection of the plasticization material from the nozzle 13, the control section 50 controls the suction feeding section 160 to execute the second operation, thereby sending out the plasticization material sucked by the suction feeding section 160 to the flow path 142, and then controls the flow rate adjustment section 143 to turn on the outflow of the plasticization material. Immediately before changing the movement direction of the nozzle 13, the control section 50 controls the suction feeding section 160 to execute the first operation while reducing the movement speed of nozzle 13, thereby preventing the line width of the plasticization material from becoming thicker as the movement speed decreases. Immediately after changing the movement direction of the nozzle 13, the control section 50 controls the suction feeding section 160 to execute the second operation while increasing the movement speed of nozzle 13, thereby preventing the line width of the plasticization material from becoming narrower as the movement speed increases.

The pressure sensor 170 is used to measure the pressure of the plasticization material in the flow path 142. The control section 50 measures the pressure of the plasticization material in the flow path 142 using the pressure sensor 170. A specific configuration of the pressure sensor 170 will be described later.

The stage 20 is disposed at a position facing the ejection port 145 of the nozzle 13. The three dimensional molding device 100 molds the three dimensional molded object by ejecting the plasticization material from the nozzle 13 toward a molding surface 21 of the stage 20 to stack molding layers.

The position changing section 30 changes the relative positions of the nozzle 13 and the stage 20. In the present embodiment, the position changing section 30 moves the material supplying device 10 along the Z direction, which is the stacking direction of the molding layers, and moves the stage 20 in a direction crossing the stacking direction, thereby changing the relative position between the nozzle 13 and the stage 20. More specifically, the position changing section 30 of the present embodiment changes the relative position between the nozzle 13 and the stage 20 in the Z direction by moving the material supplying device 10 along the Z direction and changes the relative position between the nozzle 13 and the stage 20 in the X direction and the Y direction by moving the stage 20 in the X direction and the Y direction. As shown in FIG. 1, the position changing section 30 is constituted by a first electric actuator 31 that moves the stage 20 along the X direction, a second electric actuator 32 that moves the stage 20 and the first electric actuator 31 along the Y direction, and a third electric actuator 33 that moves the material supplying device 10 along the Z direction. The third electric actuator 33 moves the first material supplying device 10a and the second material supplying device 10b along the Z direction by moving, along the Z direction, a movable section 41 to which the first material supplying device 10a and the second material supplying device 10b are fixed. Note that in FIG. 2, the third electric actuator 33 and the movable section 41 are omitted.

The first electric actuator 31, the second electric actuator 32, and the third electric actuator 33 described above are driven under the control of the control section 50. Note that, for example, the position changing section 30 may move the stage 20 in the Z direction and move the material supplying device 10 along the X direction and the Y direction, may move the stage 20 in the X direction, the Y direction, and the Z direction without moving the material supplying device 10, or may move the material supplying device 10 in the X direction, the Y direction, and the Z direction without moving the stage 20.

The first heating section 40 is a plate-shaped heater that heats the plasticization material stacked on the stage 20. The first heating section 40 is fixed to the movable section 41. The first heating section 40 is moved in the Z direction by the third electric actuator 33 together with the material supplying device 10. The first heating section 40, as shown in FIG. 2, is provided with an opening 42 that penetrates in the Z direction. When the three dimensional molded object is molded by ejecting the plasticization material, the nozzle 13 is positioned in opening 42 and the tip end of the nozzle 13 is disposed between the first heating section 40 and the stage 20 in the Z direction.

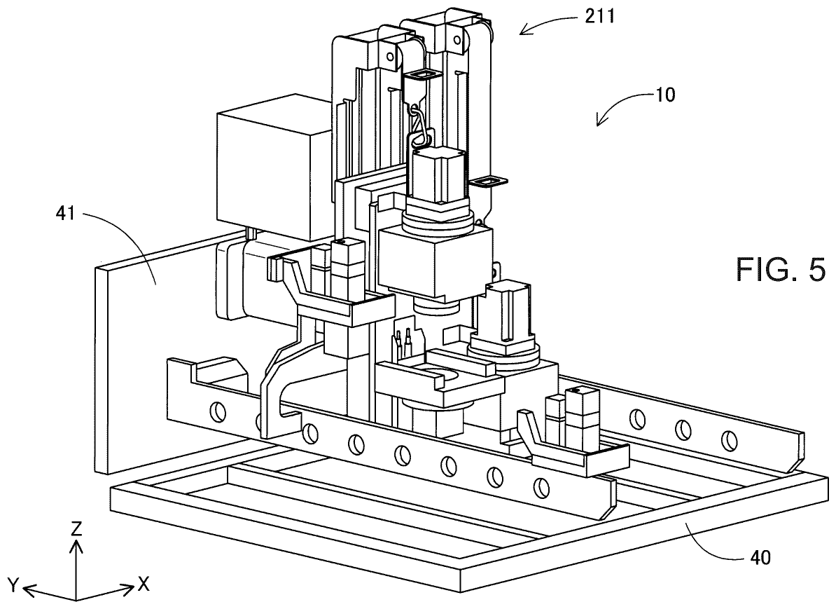

FIG. 5 is a perspective view of the movable section 41 and the material supplying device 10. FIG. 5 shown a state in which the upper case 151 of the three dimensional molding device 100 is separated from the lower case 152. The upper case 151 can be separated from the lower case 152 during maintenance or similar operations of the three dimensional molding device 100. A support section 211 is fixed to the movable section 41. The support section 211 is configured to be able to hang from the upper case 151 when the upper case 151 is separated from the lower case 152.

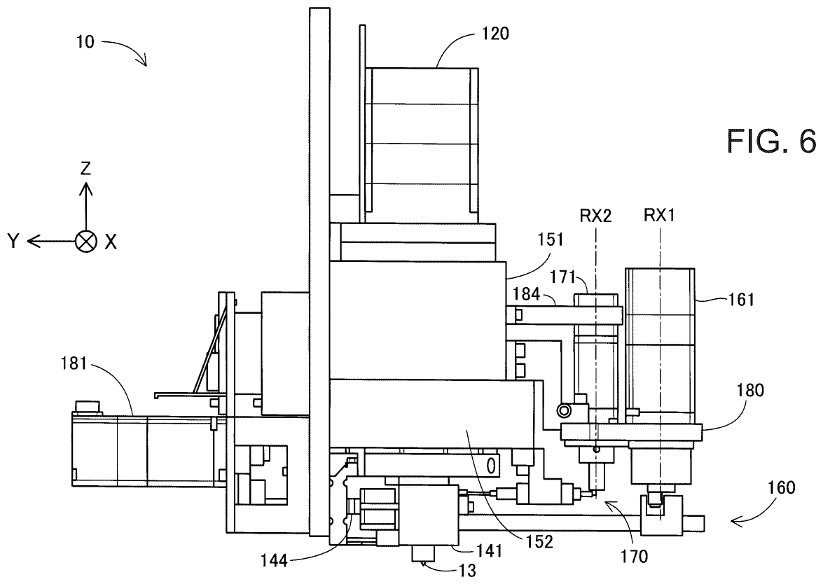

FIG. 6 is a side view of the material supplying device 10. As described above, the material supplying device 10 includes the suction feeding section 160 and the pressure sensor 170. A first motor support member 180 and a second motor support member 184 are fixed to a side surface of the upper case 151 on the −Y direction side. The first motor support member 180 supports a first motor 161 as a drive section for driving the suction feeding section 160. The second motor support member 184 supports a second motor 171 used in the operation of the pressure sensor 170. The first motor 161 and the second motor 171 are fixed to the upper case 151 by the first motor support member 180 and the second motor support member 184. A rotational axis RX1 of the first motor 161 and a rotational axis RX2 of the second motor 171 are along the Z direction. A flow amount adjustment motor 181 for rotating the valve provided in the flow rate adjustment section 143 is provided on the opposite side of the suction feeding section 160 and the pressure sensor 170 interposed the upper case 151 and the lower case 152. The flow rate adjustment section 143 includes, in addition to the valve, the flow amount adjustment motor 181 and a coupling 144 for transmitting a rotational force of the flow amount adjustment motor 181 to the valve.

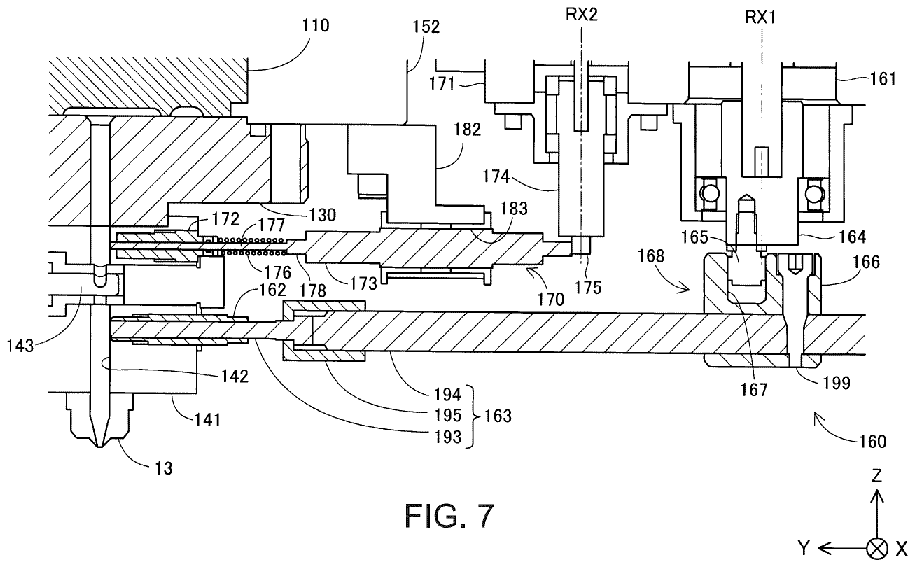

FIG. 7 is a cross-sectional view showing a configuration of the suction feeding section 160 and the pressure sensor 170. The suction feeding section 160 has a first cylinder 162 and a plunger 163. The first cylinder 162 communicates with the flow path 142 through which the plasticization material flows. In the present embodiment, the first cylinder 162 communicates with the flow path 142 downstream of the flow rate adjustment section 143. The first cylinder 162 is provided along the Y direction orthogonal to the direction in which the flow path 142 extends. The plunger 163 slides within the first cylinder 162. A tip end section of the plunger 163 is disposed in the first cylinder 162, and a rear end section of the plunger 163 is positioned near the lower section of the first motor 161. The plunger 163 is configured such that a tip end member 193 and a rear end member 194 are fastened by a fastening member 195.

A first drive shaft 164 of the first motor 161 includes a first connecting section 165, which is eccentric with respect to the rotational axis RX1 of the first drive shaft 164. The first connecting section 165 is constituted by, for example, a cam follower or a roller follower. The plunger 163 has an engagement section 166 at the rear end section of the plunger 163. The engagement section 166 is fixed to the rear end member 194 of the plunger 163 by a bolt 199. A recess section 167 is formed in the engagement section 166, is recessed along the Z direction, and is engaged with the first connecting section 165. The first connecting section 165 and the engagement section 166 constitute a conversion mechanism 168 that converts the rotational motion of the first motor 161 into the linear motion of the plunger 163. This conversion mechanism 168 is also referred to as a scotch yoke mechanism.

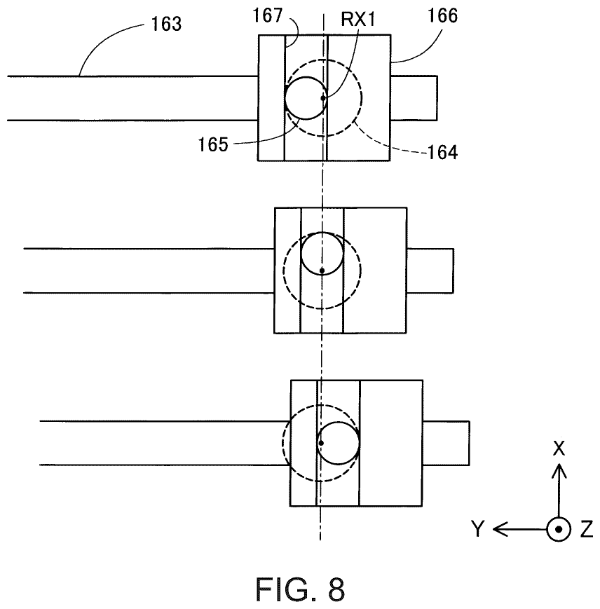

FIG. 8 is an explanatory view of the operation of plunger 163. FIG. 8 shows the plunger 163, the engagement section 166, and the first connecting section 165 as viewed in the −Z direction. As shown in FIG. 8, the recess section 167 is formed in the engagement section 166 along the X direction.

In the upper part of FIG. 8, the first connecting section 165 is shown in a state of being eccentric in the +Y direction with respect to the rotational axis RX1 of the first drive shaft 164. When the control section 50 rotates the first drive shaft 164 clockwise by 90° from this state, as shown in the central part of FIG. 8, the first connecting section 165 rotates around the rotational axis RX1 and moves within the recess section 167, whereby the plunger 163 moves in the −Y direction. When the control section 50 further rotates the first drive shaft 164 clockwise by 90°, as shown in the lower part of FIG. 8, the first connecting section 165 moves in the recess section 167, whereby the plunger 163 moves further in the −Y direction. The control section 50 controls the first motor 161 to rotate the first connecting section 165 provided on the first drive shaft 164 around the rotational axis RX1, thereby sliding the plunger 163 in the first cylinder 162 and executing the first operation and the second operation described above.

As shown in FIG. 7, in the present embodiment, the tip end section of the plunger 163 is supported by the first cylinder 162, and the rear end side beyond the first cylinder 162 is not supported. An engagement section 166 provided on the plunger 163 is provided with the recess section 167 that opens in the +Z direction, and a first connecting section 165 that protrudes from the first drive shaft 164 in the −Z direction fits into the recess section 167. According to such a structure, the plunger 163 is engaged with the first drive shaft 164 of the first motor 161 so as to be allowed to move along the Z direction.

The pressure sensor 170 is constituted by the second motor 171, a second cylinder 172, and a rod 173. The second cylinder 172 and the rod 173 are provided in the flow path block 141. The second cylinder 172 communicates with the flow path 142 through which the plasticization material flows. In the present embodiment, the second cylinder 172 communicates with the flow path 142 upstream of the flow rate adjustment section 143. The second cylinder 172 is provided along the Y direction orthogonal to the direction in which the flow path 142 extends. The tip end of the second cylinder 172 is connected to the flow path 142, and the rear end of the second cylinder 172 is exposed to the outside of the flow path block 141. The rod 173 slides in the second cylinder 172. A tip end section of the rod 173 is disposed in the second cylinder 172, and a rear end section of the rod 173 is positioned near the lower section of the second motor 171. The central section of the rod 173 is inserted into a through hole 183 of a stay 182 fixed to the lower case 152. The rod 173 is slidable in the Y direction within the through hole 183.

A second drive shaft 174 of the second motor 171 includes a second connecting section 175, which is eccentric with respect to the rotational axis RX2 of the second drive shaft 174. The second connecting section 175 is constituted by, for example, a cam follower or a roller follower. In FIG. 7, the second connecting section 175 is eccentric in the +X direction with respect to the center of the rotational axis RX2. The rear end of the rod 173 that contacts a side surface of the second connecting section 175 from the +Y direction side. According to such a configuration, the rod 173 is engaged with the second drive shaft 174 of the second motor 171 so as to be allowed to move along the Z direction.

The rod 173 includes a small-diameter section 177 and a large-diameter section 178, which has a diameter larger than that of the small-diameter section 177. The large-diameter section 178 is positioned on the −Y direction side of the small-diameter section 177. The length of the small-diameter section 177 is larger than the length of the second cylinder 172. A biasing member 176 is disposed between the second cylinder 172 and the large-diameter section 178. The small-diameter section 177 is inserted through the biasing member 176 and the second cylinder 172. The biasing member 176 is, for example, a coil spring. The biasing member 176 biases the rod 173 in a direction away from the flow path 142. By this, the rear end of the rod 173 is always in contact with the side surface of the second connecting section 175, and a predetermined torque or more is always applied to the second drive shaft 174 from the rod 173.

The second motor 171 operates such that the rod 173 is held at a predetermined position in the second cylinder 172. A function for realizing such an operation is referred to as a servo lock function. With this operation, the second motor 171 maintains the rotational position of the second drive shaft 174 so that the rod 173 does not move in the second cylinder 172 due to the pressures of the plasticization material in the flow path 142. In other words, the second motor 171 operates the rod 173 so that the rod 173 does not move due to the pressure of the plasticization material. In such an operation, the larger the force that the rod 173 receives from the flow path 142 and the biasing member 176, the larger the torque that the second motor 171 applies to the second drive shaft 174, so as to cancel the force. Therefore, the control section 50 can detect the pressure in the flow path 142 according to the torque value, that is, the current value of the second motor 171.

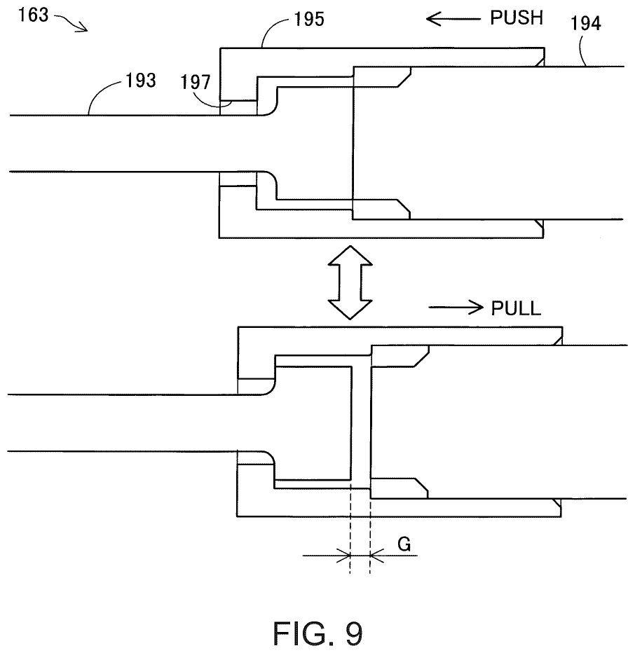

FIG. 9 is a view showing an enlarged cross-section of a part of the plunger 163. The plunger 163 is configured by using a fastening member 195 to fasten a rod-shaped tip end member 193 having a flange section at its rear end and a rod-shaped rear end member 194 having a larger diameter than the tip end member 193. A male screw is formed at a tip end section of the rear end member 194. The fastening member 195 is formed in a cylindrical shape with a bottom section. On an inner peripheral surface of the fastening member 195, a female thread that screws onto the male thread of the rear end member is formed. A through hole 197 is formed in the bottom section of the fastening member 195. With the tip end member 193 inserted into the through hole 197 of the fastening member 195 from the rear end member 194 side, the female thread of the fastening member 195 is screwed into the male thread of the rear end member 194, whereby the tip end member 193 and the rear end member 194 are fastened together by the fastening member 195. If the fastening force by the fastening member 195 is insufficient or looseness occurs, as shown in the lower part of FIG. 9, a gap G is generated between the tip end member 193 and the fastening member 195. As a result, as shown in the upper part of FIG. 9, in the second operation of pushing the plunger 163, the gap G in the fastening member 195 is filled, and in the first operation of pulling the plunger 163, the gap G is created in the fastening member 195. This gap G contributes to a backlash occurring in the suction feeding section 160 as the supply control mechanism 148. Note that the backlash may occur not only between the tip end member 193 and the rear end member 194 but also, for example, at the following positions.

(1) A gap between the recess section 167 formed in the engagement section 166 and the first connecting section 165.

(2) A gap that occurs by wear of a rolling element in the cam follower or the roller follower constituting the first connecting section 165.

(3) A gap that occurs between a machine key and a groove, of the first motor 161.

(4) A gap due to wear of a bearing of the first motor 161.

(5) A gap that occurs due to a taper machining accuracy of a bolt 199 for fastening the engagement section 166 and the plunger 163.

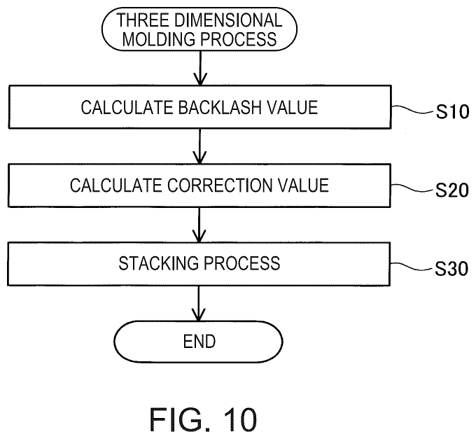

FIG. 10 is a flowchart of the three dimensional molding process executed by the control section 50. In step S10, the control section 50 calculates a backlash value representing the backlash of the suction feeding section 160 based on detection data including detection value output from the pressure sensor 170. The backlash value is expressed by an operation delay time of the suction feeding section 160 or the distance of the gap existing in the suction feeding section 160. The detection data means data including, in time series, the detection values output from the pressure sensor 170 at least a part of a period during the first operation of using the suction feeding section 160 to reduce the supply amount of the plasticization material from the nozzle 13 and a period during the second operation of using the suction feeding section 160 to increase the supply amount of the plasticization material from the nozzle 13. A method of calculating the backlash value will be described later.

In step S20, the control section 50 calculates a correction value for correcting the control timing of the suction feeding section 160 based on the backlash value calculated in step S10.

In step S30, the control section 50 executes a stacking process based on molding data. Before the three dimensional molding process, the control section 50 acquires the molding data from another device or a recording medium and stores it in the storage section 52. In the molding data are recorded a movement path of the nozzle 13 and a supply amount of the plasticization material from the nozzle 13 in each movement path. In the stacking process, the control section 50 controls the position changing section 30, the flow rate adjustment section 143, and the suction feeding section 160 in accordance with the molding data to supply the plasticization material to the stage 20 while moving the nozzle 13, thereby stacking a plurality of molding layers on the molding surface 21 and molding the three dimensional molded object. In the stacking process, the control section 50 corrects the control timing of the suction feeding section 160 when the first operation or the second operation is performed, based on the correction value calculated in step S20.

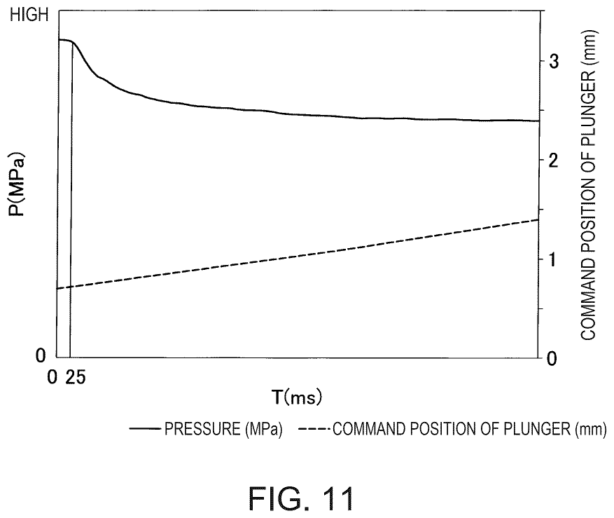

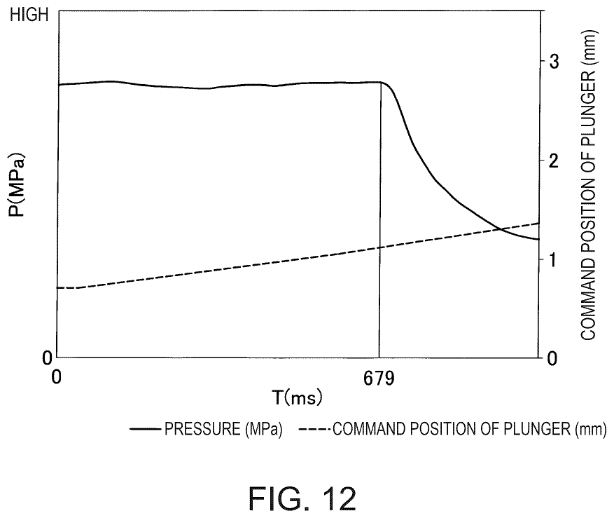

FIG. 11 and FIG. 12 are explanatory views showing a method of calculating the backlash. FIG. 11 shows the relationship between the command position of the plunger 163 and the pressure measured by the pressure sensor 170 with the passage of time when the backlash is small. FIG. 12 shows the relationship between the command position of the plunger 163 and the pressure measured by the pressure sensor 170 with the passage of time when the backlash is large. The command position of the plunger 163 represents the distance from an inner side surface of flow path 142 to a tip end surface of the plunger 163. In FIG. 11 and FIG. 12, at a time T of 0 ms, the operation of pulling the plunger 163, that is, the first operation, is started. In the example shown in FIG. 11, a pressure P detected by the pressure sensor 170 starts to decrease with a 25 ms delay from the start of the operation of the plunger 163. In the example shown in FIG. 12, the pressure P detected by the pressure sensor 170 starts to decrease with a 679 ms delay from the start of the operation of the plunger 163. Assuming that the first motor 161, which operates the plunger 163, has a rotation speed of 18 degrees/second, then in the example shown in FIG. 11, the backlash becomes 0.45 degrees in terms of the rotational angle of the first motor 161, and this rotational angle is converted into a movement distance of the plunger 163 via the conversion mechanism 168 shown in FIG. 8 and becomes 23 μm. In the example shown in FIG. 12, the backlash becomes 12.22 degrees in terms of the rotational angle of the first motor 161, and this rotational angle is converted into the movement distance of the plunger 163 via the conversion mechanism 168 and becomes 635 μm. The control section 50, based on a predetermined function or table, can perform a conversion to the movement distance of the plunger 163 from the rotational angle. In this way, the control section 50 determines the delay time from the start of operation of the plunger 163 to the change in the detection value of pressure P detected by the pressure sensor 170 and the movement distance of the plunger 163 based on the detection data and uses the delay time and movement distance as the correction value in above step S20. For example, it is assumed that when the backlash is not corrected, the distance for pulling the plunger 163 is set to 1 mm and an operation command timing for causing the plunger 163 to execute the first operation is set to −10 ms, which is earlier than a scheduled time for changing the movement direction of the nozzle 13. In this case, if the backlash shown in FIG. 12 is detected, the control section 50 sets the distance to pull the plunger 163 to 1.635 mm (=1 mm+635 μm), and sets the operation start timing of the plunger 163 to −689 ms (=−10 ms-679 ms). In this way, it is possible to suppress the occurrence of a delay in the operation of the plunger 163 and the occurrence of an insufficient amount of operation of the plunger 163 due to the presence of backlash.

The control section 50 can calculate an elapsed change amount of the backlash value by comparing the detection data acquired at a first timing with the detection data acquired at a second timing later than the first timing. For example, when the detection data at the first timing shown in FIG. 11 is compared with the detection data at the second timing shown in FIG. 12, the control section 50 can calculate that the operation start of the plunger 163 is delayed by 654 ms (=679 ms-25 ms) and the backlash is increased by 612 μm (=635 μm-23 μm) at the second timing as compared with the first timing. The control section 50 may cause a display device that is connected to the control section 50 to display the elapsed change amount of the calculated backlash value.

According to the first embodiment described above, the control section 50 calculates the backlash value based on the time series data of the detection value output from the pressure sensor 170 that measures the pressure of the plasticization material. Therefore, the backlash can be measured without disassembling the three dimensional molding device 100.

According to the present embodiment, it is possible to accurately operate the supply control mechanism 148 by calculating the correction value based on the calculated backlash value and controlling the supply control mechanism 148 based on the correction value. As a result, the molding accuracy of the three dimensional molded object can be improved.

According to the present embodiment, by comparing the detection data acquired in the first time period and the second time period, which is later than the first time period, it is possible to calculate the elapsed change amount of the backlash value. Therefore, the elapsed change amount of the backlash value can be determined without disassembling the three dimensional molding device 100. As a result, since the degree of wear of each part of the supply control mechanism 148 can be checked for elapsed time, a maintenance plan such as the replacement of parts can be easily made.

In the present embodiment, the supply control mechanism 148 and the pressure sensor 170 are supported by different members. Specifically, the first motor 161 included in the suction feeding section 160 as the supply control mechanism 148 is supported by the first motor support member 180 and the second motor 171 included in the pressure sensor 170 is supported by the second motor support member 184. Therefore, it is possible to prevent the vibration generated in the supply control mechanism 148 from affecting the detection of the pressure by the pressure sensor 170.

Note that in the first embodiment, the control section 50 calculates the backlash value in the first operation of pulling the plunger 163, but it may calculate the backlash value in the second operation of pushing the plunger 163.

### B. Second Embodiment

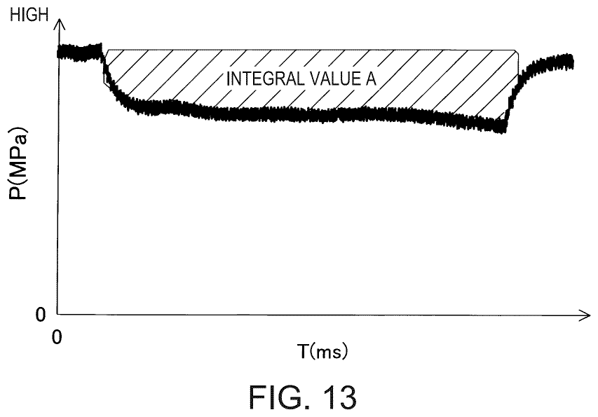

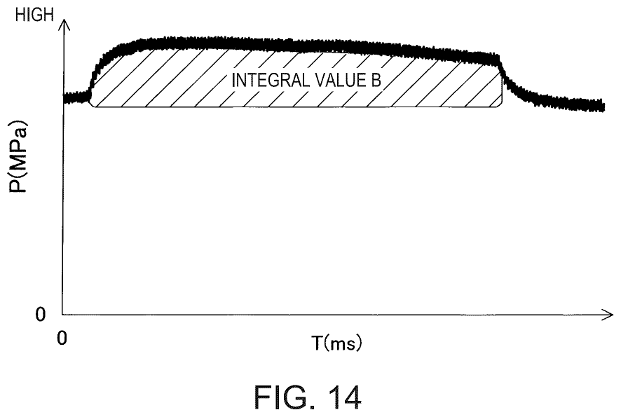

FIG. 13 and FIG. 14 are explanatory views showing a method of calculating the backlash according to a second embodiment. The configuration of the three dimensional molding device 100 in the second embodiment is the same as that in the first embodiment. In the second embodiment, the method of calculating the backlash in step S10 of the three dimensional molding process shown in FIG. 10 is different from that in the first embodiment.

FIG. 13 shows a change in the pressure P when the plunger 163 is caused to execute the first operation, and the plunger 163 is pulled by 1.6 mm during a period from 200 ms to 2200 ms after the measurement of the pressure P is started. FIG. 14 shows a change in the pressure P when the plunger 163 is caused to execute the second operation, and the plunger 163 is pushed by 1.6 mm during a period from 200 ms to 2200 ms after the measurement of the pressure P is started. In the second embodiment, the control section 50 determines a time integral value A of the pressure in the operation of pulling the plunger 163 and a time integral value B of the pressure in the operation of pushing the plunger 163. Then, a backlash value X is calculated based on the following Equation (1). Note that L is the movement amount of plunger 163. In Equation (1), it is assumed that the gap is generated due to the backlash when the plunger 163 is pulled.

$$B : L = A : ( L - X )$$

### That is.

$$X = L ( 1 - A / B ) \qquad ( 1 )$$

According to the second embodiment described above, it is possible to accurately calculate the backlash value based on the time integral value of the pressure when pulling the plunger 163 and the time integral value of the pressure when pressing the plunger 163.

### C. Third Embodiment

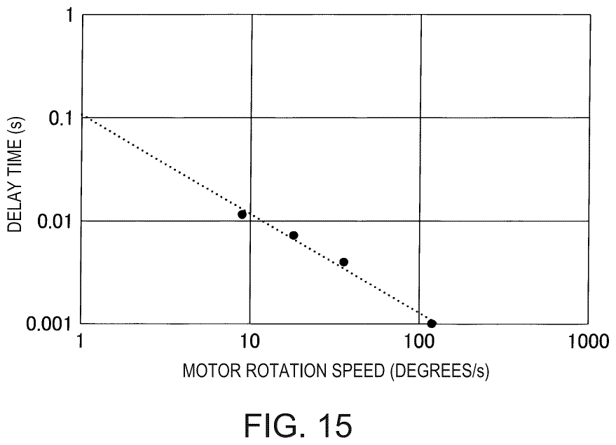

FIG. 15 is an explanatory view showing a method of calculating the backlash according to a third embodiment. The configuration of the three dimensional molding device 100 in the third embodiment is the same as that in the first embodiment. In the third embodiment, the method of calculating the backlash in step S10 of the three dimensional molding process shown in FIG. 10 is different from that in the first embodiment.

In the third embodiment, the control section 50 varies the rotation speed of the first motor 161 for moving the plunger 163, and at each rotation speed, as in the first embodiment, the time at which the detected value of the pressure sensor 170 starts to change is determined as a delay time. Then, the delay time with respect to each rotation speed is plotted on a log-log graph, an approximate straight line for each plot is obtained, and the intercept is calculated. Then, the value of the intercept becomes the backlash value corresponding to the rotational angle of the first motor 161. For example, assuming that the backlash value obtained by the intercept of FIG. 15 is 0.108 degrees, the rotational angle is converted into the movement distance of the plunger 163 by the conversion mechanism 168 shown in FIG. 8 and becomes, for example, 0.0024 mm.

According to the third embodiment described above, while changing the operating speed of the suction feeding section 160 as the supply control mechanism 148, the operation delay time of the supply control mechanism 148 corresponding to each operating speed is calculated based on the detection data, and the backlash value can be calculated based on the correlation between the operating speed and the operation delay time. The backlash value can also be calculated with high accuracy by such a method.

### D. Fourth Embodiment

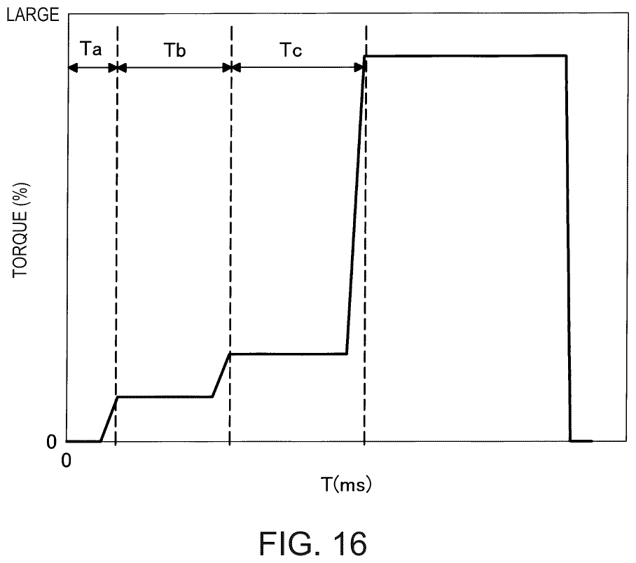

FIG. 16 is an explanatory view showing a method of calculating the backlash according to a fourth embodiment. The configuration of the three dimensional molding device 100 in the fourth embodiment is the same as that in the first embodiment. In the fourth embodiment, in step S10 of the three dimensional molding process shown in FIG. 10, the control section 50 calculates the backlash value based on the detection value of the pressure sensor 170 and calculates the backlash value for each occurrence place of the backlash based on the torque change of the first motor 161.

In the fourth embodiment, the control section 50 moves the plunger 163 at a constant speed and detects the torque change of the first motor 161 during the movement. The vertical axis of FIG. 16 shows the torque change of the first motor 161 after the start of the movement of the plunger 163. FIG. 16 shows a state in which the torque changes in three stages. A time Ta until the torque changes for the first time corresponds to the backlash value in the bearing of the first motor 161. A time Tb until the torque changes for the second time corresponds to the backlash value in the conversion mechanism 168. A time Tc until the torque changes for the third time corresponds to the backlash value in the fastening member 195 of the plunger 163. The torque increase at the time Tb is caused by a mechanical loss in the bearing of the first motor 161. The torque increase at the time Tc is caused by a mechanical loss in the conversion mechanism 168. The torque increase after the time Tc is due to resistance as the tip end of the plunger 163 pushes against the plasticization material. The control section 50 can calculate the backlash value for each occurrence place of the backlash by measuring the interval at which the torque change occurs in this manner.

According to the fourth embodiment described above, by analyzing the torque change of the first motor 161 at the time of movement of the plunger 163, the control section 50 can calculate the backlash value in each section of the supply control mechanism 148. The control section 50 can also analyze the presence or absence of the backlash in each section of the supply control mechanism 148, that is, the position of the backlash, according to the presence or absence of the torque change. For example, the control section 50 may display the backlash value for each backlash occurrence position on a display section connected to the control section 50.

### E. Fifth Embodiment

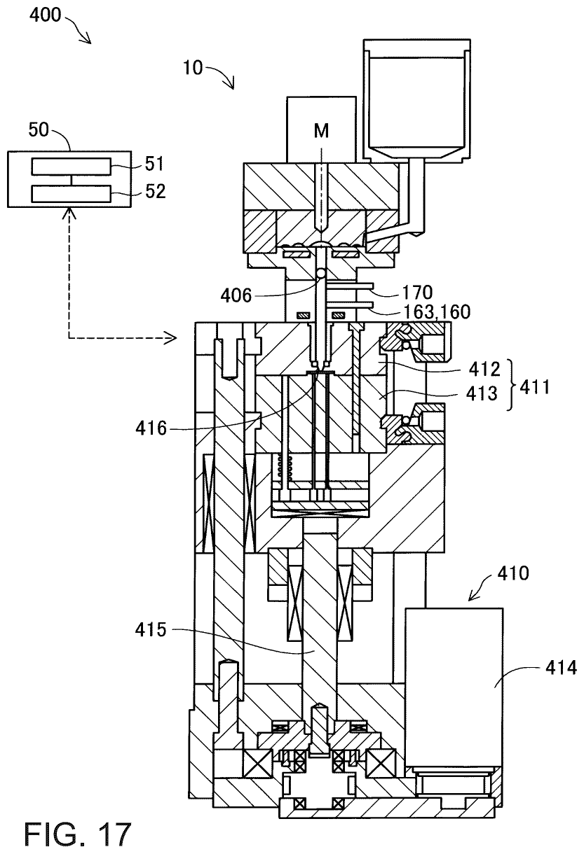

FIG. 17 is an explanatory view showing a schematic configuration of an injection molding device 400 according to a fifth embodiment. The injection molding device 400 includes the material supplying device 10, a molding die clamping device 410 for opening and closing a molding die 411, and the control section 50. In FIG. 17, elements corresponding to the various elements of the first embodiment are denoted by the same reference symbols.

The configuration of the material supplying device 10 in the fifth embodiment is substantially the same as the configuration of the material supplying device 10 in the first embodiment. However, the material supplying device 10 of the fifth embodiment includes a check valve 406 instead of the flow rate adjustment section 143. The check valve 406 is provided upstream in the flow path 142 from the suction feeding section 160 and the pressure sensor 170. The check valve 406 prevents backflow of the plasticization material in the flow path 142.

The suction feeding section 160 in the present embodiment has a function of measuring and injecting the plasticization material. The control section 50 stops the supply of the plasticization material from the nozzle 13 and measures the plasticization material by executing the first operation of pulling the plunger 163 of the suction feeding section 160, and sends out the plasticization material to the flow path 142 and supplies the plasticization material from the nozzle 13 to the molding die 411 by executing the second operation of pushing the plunger 163.

The molding die 411 is composed of a fixed molding die 412 and a movable molding die 413. The fixed molding die 412 is fixed to the material supplying device 10. The movable molding die 413 is provided so as to be movable forward and backward in the mold clamping direction relative to the fixed molding die 412 by the molding die clamping device 410. The plasticization material generated by the material supplying device 10 is injected from the nozzle 13 into a cavity 416 defined by the fixed molding die 412 and the movable molding die 413. The molding die 411 may be made of metal, plastic, or ceramic.

The molding die clamping device 410 includes a molding die drive section 414. The molding die drive section 414 is constituted by a motor, a gear, or the like, and is connected to the movable molding die 413 via a ball screw 415. By drive of the molding die drive section 414 under the control of the control section 50, the molding die clamping device 410 rotates the ball screw 415 to open and close the molding die 411 by moving the movable molding die 413 relative to the fixed molding die 412.

Also in the fifth embodiment described above, as in the first embodiment, prior to injection molding, the control section 50 can calculate the backlash value based on the time series data of the detection value output from the pressure sensor 170 that measures the pressure of the plasticization material. Therefore, the backlash can be measured without disassembling the injection molding device 400. By calculating the correction value based on the calculated backlash value and controlling the suction feeding section 160 based on the correction value, the plasticization material can be accurately measured and injected. Therefore, the quality of the molded article can be improved.

### F. Other Embodiments

(F1) In each of the embodiments described above, the measurement of the backlash in the suction feeding section 160 was described. The measurement of the backlash is not limited to the suction feeding section 160, and it may also be performed on the flow rate adjustment section 143 as the supply control mechanism 148. In the flow rate adjustment section 143, for example, the backlash may be present in a bearing of the flow amount adjustment motor 181 or the coupling 144. Note that the first operation in the flow rate adjustment section 143 is an operation of closing the valve in order to decrease the supply amount of the plasticization material from the nozzle 13 and the second operation in the flow rate adjustment section 143 is an operation of opening the valve in order to increase the supply amount of the plasticization material from the nozzle 13.

(F2) In the above embodiment, the first motor 161 that drives the plunger 163 and the second motor 171 that constitutes the pressure sensor 170 are supported by different motor support members 180 and 184. However, the first motor 161 and the second motor 171 may be supported by the same support member.

(3) In the above embodiment, the three dimensional molding device 100 is provided with two material supplying devices 10. On the other hand, the three dimensional molding device 100 may include one or three or more material supplying devices 10.

### G. Other Forms

The present disclosure is not limited to the above described embodiments, and can be realized in various configurations without departing from the spirit thereof. For example, the technical features of the embodiments corresponding to the technical features in each aspect described below can be appropriately replaced or combined in order to solve a part or all of the problems described above or to achieve a part or all of the effects described above. Unless the technical features are described as essential in the present specification, the technical features can be appropriately deleted.

(1) According to a first aspect of the present disclosure, a material supplying device is provided.

This material supplying device includes a plasticizing section configured to plasticize a material to generate a plasticization material; a nozzle configured to supply the plasticization material to outside; a supply control mechanism that is provided in a flow path communicating with the plasticizing section and the nozzle and that is configured to adjust supply amount of the plasticization material from the nozzle to outside; a pressure sensor configured to measure the pressure of the plasticization material in the flow path; and a control section configured to control operation of the supply control mechanism, wherein the control section is configured to calculate a backlash value indicating backlash of the supply control mechanism based on detection data including a detection value output from the pressure sensor and the detection data is data including, in time series, the detection values output from the pressure sensor in at least a part of a period during a first operation of using the supply control mechanism to reduce the supply amount of the plasticization material from the nozzle and a period during a second operation of using the supply control mechanism to increase the supply amount of the plasticization material from the nozzle.

According to such an aspect, since the backlash is calculated based on the time series data of the detected value output from the pressure sensor for measuring the pressure of the plasticization material, the backlash can be measured without disassembling the device.

(2) The above aspect may be such that the control section is configured to calculate an elapsed change amount of the backlash value by comparing the detection data acquired at a first timing with the detection data acquired at a second timing that is later than the first timing.

According to such an aspect, the elapsed change amount in the backlash value can be determined without disassembling the device.

(3) The above aspect may be such that the supply control mechanism includes a cylinder connected to the flow path, a plunger disposed in the cylinder, and a drive section configured to drive the plunger, the control section is configured to execute the first operation by controlling the drive section to pull the plunger to suck the plasticization material from the flow path into the cylinder and the second operation by controlling the drive section to push the plunger to send out the plasticization material in the cylinder to the flow path, and the control section is configured to calculate the backlash value based on a time integral value of the detection value during a period of the first operation and a time integral value of the detection value during a period of the second operation.

According to such an aspect, the backlash can be calculated with high accuracy.

(4) The above aspect may be such that the control section is configured to calculate, while changing the operating speed of the supply control mechanism, an operation delay time of the supply control mechanism corresponding to each operating speed based on the detection data and is configured to calculate the backlash value based on a correlation between the operating speed and the operation delay time.

According to such an aspect, the backlash can be calculated with high accuracy.

(5) The above aspect may be such that the control section is configured to control an operation of the supply control mechanism based on the calculated backlash value.

According to such an aspect, the supply control mechanism can be operated accurately.

(6) The above aspect may be such that the supply control mechanism includes a cylinder connected to the flow path, a plunger disposed in the cylinder, a drive section that includes a motor configured to drive the plunger, and a conversion mechanism configured to convert rotational motion of the motor into linear motion of the plunger and the control section is configured to calculate the backlash value for each occurrence place of backlash based on torque changes of the motor.

According to such an aspect, the backlash can be measured for each backlash occurrence position without disassembling the device.

(7) The above aspect may be such that the supply control mechanism and the pressure sensor are supported by different members.

According to such an aspect, it is possible to suppress the backlash existing in the supply control mechanism from affecting the measurement by the pressure sensor.

The present disclosure is not limited to the form as the material supplying device described above, and can be realized by various forms such as a three dimensional molding device including the material supplying device and an injection molding device including the material supplying device.

What is claimed is:

1. A material supplying device comprising:
a plasticizing section configured to plasticize a material to generate a plasticization material;
a nozzle configured to supply the plasticization material to outside;
a supply control mechanism that is provided in a flow path communicating with the plasticizing section and the nozzle and that is configured to adjust supply amount of the plasticization material from the nozzle to outside;
a pressure sensor configured to measure the pressure of the plasticization material in the flow path; and
a control section configured to control operation of the supply control mechanism, wherein
the control section is configured to calculate a backlash value indicating backlash of the supply control mechanism based on detection data including a detection value output from the pressure sensor and
the detection data is data including, in time series, the detection values output from the pressure sensor in at least a part of a period during a first operation of using the supply control mechanism to reduce the supply amount of the plasticization material from the nozzle and a period during a second operation of using the supply control mechanism to increase the supply amount of the plasticization material from the nozzle.

2. The material supplying device according to claim 1, wherein
the control section is configured to calculate an elapsed change amount of the backlash value by comparing the detection data acquired at a first timing with the detection data acquired at a second timing that is later than the first timing.

3. The material supplying device according to claim 1, wherein
the supply control mechanism includes a cylinder connected to the flow path, a plunger disposed in the cylinder, and a drive section configured to drive the plunger,
the control section is configured to execute
the first operation by controlling the drive section to pull the plunger to suck the plasticization material from the flow path into the cylinder and
the second operation by controlling the drive section to push the plunger to send out the plasticization material in the cylinder to the flow path, and
the control section is configured to calculate the backlash value based on a time integral value of the detection value during a period of the first operation and a time integral value of the detection value during a period of the second operation.

4. The material supplying device according to claim 1, wherein
the control section is configured to calculate, while changing the operating speed of the supply control mechanism, an operation delay time of the supply control mechanism corresponding to each operating speed based on the detection data and is configured to calculate the backlash value based on a correlation between the operating speed and the operation delay time.

5. The material supplying device according to claim 1, wherein
the control section is configured to control an operation of the supply control mechanism based on the calculated backlash value.

6. The material supplying device according to claim 1, wherein
the supply control mechanism includes a cylinder connected to the flow path, a plunger disposed in the cylinder, a drive section that includes a motor configured to drive the plunger, and a conversion mechanism configured to convert rotational motion of the motor into linear motion of the plunger and
the control section is configured to calculate the backlash value for each occurrence place of backlash based on torque changes of the motor.

7. The material supplying device according to claim 1, wherein
the supply control mechanism and the pressure sensor are supported by different members.

8. A three dimensional molding device comprising:
the material supplying device according to claim 1 and
a stage on which the plasticization material is supplied from the material supplying device and deposited.

9. An injection molding device comprising:
the material supplying device according to claim 1 and
a molding die clamping device configured to cause a molding die, which has a cavity into which the plasticization material is supplied from the material supplying device, to open and close.
